(19) United States
(12) Patent Application Publication
(10) Pub. No.: US 2005/0227122 A1
(43) Pub. Date: Oct. 13, 2005

(54) Vertical magnetic recording medium, method for producing the same and magnetic recorder

(76) Inventors: Migaku Takahashi, Miyagi (JP); David Djayaprawira, Miyagi (JP); Hirold Domon, Miyagi (JP)

Correspondence Address: YOUNG & THOMPSON, 745 SOUTH 23RD STREET, 2ND FLOOR, ARLINGTON, VA, 22202, US

(21) Appl. No.: 10/511,584

(22) PCT Filed: Mar. 20, 2003
(86) PCT No.: PCT/JP03/03441

§ 371 Date: May 4, 2005

(30) Foreign Application Priority Data
Apr. 16, 2002 (JP) 2002-113648

(51) Int. Cl. G11B 5/64

(52) U.S. Cl. 428/832.1; 428/832.3

(57) ABSTRACT

A vertical magnetic recording medium exhibiting excellent noise characteristics in which magnetic interaction is reduced in a magnetic layer. The vertical magnetic recording medium (10) includes a nonmagnetic substrate (1), an underlying layer (2) formed directly or indirectly on the nonmagnetic substrate (1), and a magnetic layer (4) for recording magnetic information formed on the underlying layer (2), characterized in that the underlying layer (2) is composed of an alloy principally including two kinds of element, difference of standard free energy ΔG° for producing an oxide or a nitride of the both elements at room temperature is set not lower than 70 kJ/mol[O2 or N2], and crystal grains constituting the underlying layer (2) principally includes one of two elements having a higher ΔG°, and the grain boundary of the underlying layer (2) principally includes an oxide or a nitride of an element having a lower ΔG°.

### TECHNICAL FIELD

The present invention relates to a perpendicular recording medium, the method for producing the same and a magnetic recording apparatus, and more specially to the construction of a perpendicular recording medium that improved its recording and reproducing characteristics by incorporating a underlayer having excellent characteristics, the method of producing the same and a magnetic recording apparatus having this magnetic recording medium, and the perpendicular recording medium related to the present invention is preferably used in hard disks and magnetic tapes.

### BACKGROUND ART

Lately magnetic recording media are widely used in hard disk drives as a high density recording medium of a large capacity. And in order to further enhance density, improvements in their recording and reproducing characteristics and reduction of chronological changes in magnetization are sought after in a compatible manner. And as a product satisfying these requirements, the perpendicular recording medium is attracting attention.

FIGS. 9 and 10 are schematic views of a hard disk representing an example of the perpendicular recording medium.

FIG. 9 is a perspective view of a perpendicular recording medium, and FIG. 10 is a schematic cross sectional view along the lines A-A as shown in FIG. 9.

The magnetic recording medium 90 shown in FIGS. 9 and 10 comprises a base substrate 92 composed of a nonmagnetic material, a soft magnetic underlayer 93 formed on this base substrate 92, a underlayer 94, an intermediate layer 95, a magnetic layer 96 and a protective layer 97.

The perpendicular recording medium 90 of this example comprises, for example, a base substrate 92 composed of glass, a soft magnetic underlayer 93 composed of Fe—Ni laminated on said glass base substrate 92, a underlayer 94 composed of for example indium-tin oxide (ITO), an intermediate layer 95 composed of Pd, a magnetic layer 96 composed of multiple layers of Co/Pd and a protective layer 97 composed of carbon and the like laminated successively on the soft magnetic underlayer 93. The typical thickness of each layer is 200 nm-3,000 nm for the soft magnetic underlayer 93, 1 nm-2 nm for the underlayer (ITO) 94, 2 nm-5 nm for the intermediate layer (Pd) 95, 10 nm-50 nm for the magnetic layer (multilayered film of Co/Pd) 96, and 3 nm-20 nm for the protective layer 97. It should be noted in addition that the protective layer 97 not shown may sometimes be covered with fluoric lubricants such as perfluoropolyether and the like.

With regard to hcp-CoCr alloys that have long been studied for use in the perpendicular recording medium, efforts have been made to search for materials having a higher perpendicular magnetic anisotropy from the viewpoint of magnetization stability at high temperatures. As one of such materials, said Co/Pd multilayered medium is mentioned. The Co/Pd multilayered film medium is known to have a high perpendicular magnetic anisotropy due to interfacial anisotropy in the interface between Co and Pd, and is noted as a recording medium of 300 Gb/in² or more. Due to a strong magnetic coupling, however, this medium is faced with an important issue of reducing its medium noise.

As methods for reducing the magnetic interaction of said Co/Pd multilayered medium, the following are mentioned.

The first method consists of increasing the gas pressure from several tens to several hundreds of Torr at the time of depositing on the recording medium.

The use of said method results in the formation of gaps between crystal grains of the Co/Pd multilayered medium, and consequently a reduction of magnetic interaction. (S.N. Piramanayagam et al. IEEE Trans. Magn. 33(5), 3247 (1997); Lianjun Wu et. Al. IEEE Trans. Magn, 33(5), 3094(1997)). However, the use of this method results in the surface of the medium becoming rough making it necessary to increase the flying height of the magnetic head. As a result, no improvement can be achieved in the recording density of medium. And the development of gaps among the crystal grains may bring about concerns about the corrosiveness of the medium.

Then, the adoption of a ITO oxide seed layer.

The lamination of a 1-2 nm thick ITO oxide seed layer on the surface of the substrate leads to the development of gaps among the crystal grains of the medium enabling to reduce their magnetic interaction. (W. Peng et. Al., J. Appl. Phys., 89 (9), 6358 (2,000); A. G. Roy et. al., J. Appl. Phys, 89 (11), 7531 (2001). On the other hand, the possibility of the medium surface becoming rough, the corrosiveness of the medium and the like is feared.

Then, the adoption of a seed layer containing SiO₂ such as Au—SiO₂.

When a film is formed on a target composed of Au+15 mol % SiO₂ by rf sputtering, SiO₂ forms on the grain boundary of Au crystal grains. As a result, the intergranular magnetic coupling of the Co/Pd multilayered medium reduces (Hiroyuki Ohmori, Akihiro Maesaka, The Magnetics Society of Japan, 26, 535 (2001). However, the rf sputtering film forming method involves a number of problems in that it is difficult to sputter on both sides of the medium, that the equipment is expensive and so forth. Therefore, this method is not used in the general apparatuses for the production of media.

As stated above, in order to realize a low-noise Co/Pd multilayered medium capable of coping with a recording density of 300 Gb/in² or more, it is essential to develop a new underlayer that suppresses the magnetic interaction, causes no deterioration in the surface roughness of the medium and yet cope with simple process of forming a film. Therefore, in order to overcome the above issue, the inventors of the present invention paid their attention to the underlayer that greatly affects the crystal grain diameter and the distribution of such grain diameter in the magnetic layer, and launched a project to develop the composition of a new underlayer capable of realizing a perpendicular recording medium that reduces the magnetic interaction of the magnetic layer, having a superb noise characteristic, and a process of forming film. And as a result of constant and devoted efforts, the inventors succeeded in completing the present invention.

Therefore, one of the objects of the present invention is to provide a perpendicular recording medium that solves the issues mentioned above, reduces the magnetic interaction in the magnetic layers and has an outstanding noise characteristic.

And another object of the present invention is to provide a method of producing a perpendicular recording medium having an outstanding noise characteristic.

And yet another object of the present invention is to provide a magnetic recording apparatus comprising a magnetic recording medium having said outstanding characteristic.

### DISCLOSURE OF INVENTION

In order to solve said issues, the perpendicular recording medium related to the present invention comprises a nonmagnetic base substrate, a underlayer formed directly or indirectly on said nonmagnetic base substrate, an intermediate layer formed on said underlayer, and a magnetic layer formed on said intermediate layer for recording magnetic information, wherein said underlayer comprises an alloy principally composed of two kinds of elements, the difference of standard free energy ΔG° for producing an oxide or a nitride of said both elements at room temperature is set at 70 kJ/mol [O₂ or N₂] or above, and the crystal grains constituting said underlayer are principally composed of elements having a higher value ΔG° of said two elements, and the crystal grain boundary of said underlayer is principally composed of an oxide or a nitride of said element having a lower value ΔG°.

According to the magnetic recording medium of the composition described above, in the crystal structure of the underlayer, the crystal grains are principally composed of elements having a higher value in said ΔG°, and the crystal grain boundary is principally composed of oxides or nitrides having a lower value in said ΔG°, it is possible to obtain a underlayer containing fine crystal grains and a crystal structure isolated by the crystal grain boundary. By the adoption of this structure, the crystal grains of the intermediate layer formed on the underlayer and those of the magnetic layer formed on the intermediate layer can be easily formed along the crystal structure of the underlayer, and it will be possible particularly to attenuate the magnetic interactions among the crystal grains of the magnetic layer. And it will also be possible to obtain an outstanding noise characteristic and to realize a perpendicular recording medium having an excellent recording and reproducing characteristic.

It is preferable that, in the perpendicular recording medium related to the present invention, elements with a lower value ΔG° contained in said underlayer be any one of B, Al, Si, Ti, Zr, Hf, Ta, Mn, Mg, Ca, Be and Ce.

It is preferable that, in the perpendicular recording medium related to the present invention, the contents of elements with a lower value ΔG° contained in said underlayer be 10 at % or above and 90 at % or below, and more preferable that they be 20 at % or above and 60 at % or below.

It is preferable that, in the perpendicular recording medium related to the present invention, elements with a higher value ΔG° contained in said underlayer be any one of Cu, Zn, Nb, Mo, Tc, Ru, Rh, Pd, Ag, Cd, In, Sn, Re, Os, Ir, Pt and Au.

It is preferable that, in the perpendicular recording medium related to the present invention, the contents of the element with a higher value ΔG° contained in said underlayer be 10 at % or above and 90 at % or below, and more preferable that they be 40 at % or above and 80 at % or below.

It is preferable that, in the perpendicular recording medium related to the present invention, the film thickness of said underlayer be 0.5 nm or above and 25 nm or below.

The perpendicular recording medium related to the present invention comprises an intermediate layer between said underlayer and the magnetic layer, and it is preferable that said intermediate layer has a face centered cubic structure (fcc) or a hexagonal close-packed structure (hcp).

It is preferable that, in the perpendicular recording medium related to the present invention, the film thickness of said intermediate layer be 0.5 nm or above and 10 nm or below.

In the perpendicular recording medium related to the present invention, said magnetic layer may comprise an alloy principally composed of Co and Cr.

In the perpendicular recording medium related to the present invention, said magnetic layer may be a multilayered film wherein a layer principally composed of Co and a layer principally composed of Pd are alternatively laminated one on the other a number of times.

It is preferable that, in the perpendicular recording medium related to the present invention, the layer principally composed of said Co be composed of a CoX alloy and said X be any one of B, Al, Si, Ti, Zr, Hf, Ta, Mn, Mg, Ca, Be and Ce.

The method of producing the perpendicular recording medium related to the present invention comprises a step of forming the underlayer on the nonmagnetic base substrate, a step of forming the intermediate layer on said underlayer, and a step of forming the magnetic layer for recording magnetic information on said intermediate layer, the step of forming said underlayer comprising a step of forming an oxide or a nitride of at least an element or more among the elements composing the underlayer in the underlayer.

According to the production method of such a structure, it is possible to make the crystal grains of the underlayer infinitely small by forming oxides or nitrides of the constituent elements of said underlayer in said underlayer, and due to the preferential separation of said oxides or nitrides in the crystal grain boundary, it is possible to enhance the isolation of crystal grains of the intermediate layer and the magnetic layer formed on the underlayer. Therefore, it is possible to suppress the magnetic interaction among crystal grains of the magnetic layer by enhancing the isolation of crystal grains in the intermediate layer and the magnetic layer formed on the underlayer. Therefore, according to the production method related to the present invention, it is possible to easily produce perpendicular recording media having an outstanding noise and recording/reproducing characteristics.

It is preferable that, in the method of producing perpendicular recording media related to the present invention, said underlayer be composed of an alloy principally composed of two kinds of elements, and that both of said elements be composed of two kinds of elements of which the difference of standard free energy ΔG° for producing an oxide or a nitride at room temperature is 70 kJ/mol [O₂ or N₂] or more.

It is preferable that, in the method of producing perpendicular recording media related to the present invention, in the process of forming said underlayer, a film forming gas comprising oxygen or nitrogen be used and that the partial pressure of oxygen or nitrogen in said film forming gas be 10⁻⁶ Torr or above and 6×10⁻² Torr or below.

It is preferable that, in the method of producing the perpendicular recording media related to the present invention, in the process of forming said magnetic layer, a film forming gas comprising oxygen or nitrogen be used and that the partial pressure of oxygen or nitrogen in said film forming gas be 10⁻⁶ Torr or above and 6×10⁻² Torr or below.

The method of producing the method of producing the perpendicular recording media related to the present invention may comprise a step of exposing the surface of said underlayer to an atmosphere containing oxygen or nitrogen after the deposition of said underlayer.

It is preferable that, in the method of producing the perpendicular recording medium related to the present invention, an alloy of which the element with a lower value ΔG° is any one of B, Al, Si, Ti, Zr, Hf, Ta, Mn, Mg, Ca, Be and Ce be used as the alloy composing said underlayer.

It is preferable that, in the method of producing the perpendicular recording medium related to the present invention, the contents of the element with a lower value ΔG° contained in said alloy be 10 at % or above and 90 at % or below, and more preferable that they be 20 at % or above and 60 at % or below.

It is preferable that, in the method of producing the perpendicular recording medium related to the present invention, an alloy of which the element with a higher value ΔG° is any one of Cu, Zn, Nb, Mo, Tc, Ru, Rh, Pd, Ag, Cd, In, Sn, Re, Os, Ir, Pt and Au be used as the alloy composing said underlayer.

It is preferable that, in the method of producing the perpendicular recording medium related to the present invention, the contents of the element with a higher value ΔG° contained in said alloy be 10 at % or above and 90 at % or below, and more preferable that they be 40 at % or above and 80 at % or below.

And then, the magnetic recording apparatus related to the present invention comprises the perpendicular recording medium of the present invention described above, a driving part for driving said perpendicular recording medium, and a magnetic head for recording and reproducing magnetic information, and records and reproduces magnetic information on and from said moving perpendicular recording medium by means of said magnetic head.

According to the magnetic recording apparatus of the construction described above, it is possible to record and reproduce information at a high density by means of the perpendicular recording medium of the present invention having an outstanding recording and reproducing characteristic, and at the same time it is possible to provide a magnetic recording apparatus having an outstanding reliability the magnetic characteristic of which does not deteriorate even when it is used for long hours in a heated state due to a spindle rotating at a high speed and the heating of a control chip and the like.

### BRIEF DESCRIPTION OF DRAWINGS

FIG. 1 is a cross sectional view of the magnetic recording medium constituting a form of carrying out the present invention.

FIG. 2 is a graph showing the measurements of coercive force Hc in the Embodiment 1 of the present invention.

FIG. 3 is a graph showing the measurements of anisotropic magnetic field Hk in the Embodiment 1 of the present invention.

FIG. 4 is a graph showing the measurements of coercive force and squareness ratio α in the Embodiment 2 of the present invention.

FIG. 5 is a graph showing the measurements of coercive force Hc in the Embodiment 1 of the present invention.

FIG. 6 is a graph showing the measurements of anisotropic magnetic field Hk in the Embodiment 1 of the present invention.

FIG. 7 is a cross sectional view of the magnetic recording apparatus related to the present invention.

FIG. 8 is a plane view including a partial cross section of the magnetic recording apparatus shown in FIG. 7.

FIG. 9 is a perspective view showing an example of the magnetic recording medium.

FIG. 10 is a view showing the cross sectional structure of the magnetic recording medium shown in FIG. 9.

### (DESCRIPTION OF CODES)

10 Perpendicular recording medium
1. Base substrate
2. Underlayer
3. Intermediate layer
4. Magnetic layer
4a Co layer (layer principally composed of Co)
4b Pd layer (layer principally composed of Pd)
5. Protective layer

### BEST MODE FOR CARRYING OUT THE INVENTION

The mode of carrying out the present invention will be described below with reference to drawings.

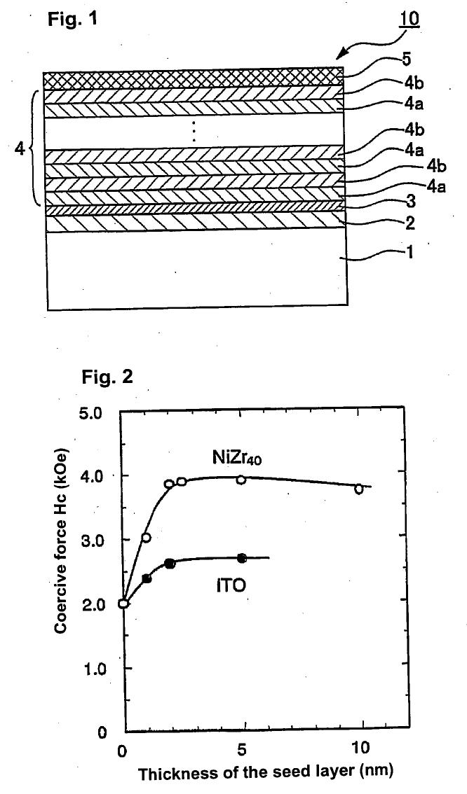

FIGS. 1 and 2 show schematically the cross sectional structure of a mode of carrying out wherein the magnetic recording medium related to the present invention is applied to a computer hard disk. And the magnetic recording medium 10 shown in FIG. 1 comprises a base substrate 1 consisting of a discoidal nonmagnetic material, a underlayer 2, an intermediate layer 3, a magnetic layer 4 and a protective layer 5 laminated one on the other. And the said magnetic layer 4 comprises a Co layer 4a principally composed of Co and a Pd layer 4b principally composed of Pd laminated alternatively one on the other a number of times from the metal underlayer 2 side. The magnetic recording medium having this kind of structure is sometimes called “Co/Pd multilayered medium” in the present specification.

And the laminated structure of the magnetic recording medium of the present mode of carrying out shown in FIG. 1 is the most basic structure of magnetic recording medium related to the present invention, and therefore an intermediate layer may be provided as required between the base substrate 1 and the magnetic layer 4 as a part of the whole structure. In addition, a lubricating layer composed of a fluoric lubricant may obviously be added on the protective layer 5.

A magnetic recording medium 10 having the basic structure of the magnetic recording medium related to the present invention will be described below with further details with reference to FIG. 1.

(Substrate)

As the base substrate 1 related to the present invention, for example, a base plate comprising aluminum and its alloy or oxide, titanium and its alloy or oxide, or silicone, glass, carbon, ceramic, plastic, resin and their compound the surface of which is coated with a nonmagnetic layer of a heterogeneous material by sputtering, deposition, electroplating and other film forming methods may be indicated.

As for the shape of the base substrate 1, for use on disks, doughnut discoidal base substrate is used. Base substrates having a ferromagnetic metal layer and the like described below, in other words magnetic recording media are rotated around the center of the disk at the time of recording and reproducing magnetic information at a speed ranging between 3,600 rpm and 5,000 rpm for example for use. At this time, a magnetic head runs flying at a height of approximately 0.1 μm or several tens of nm above the surface or the back of the magnetic recording medium. In addition, magnetic heads that run flying at a low flying height of 10 nm or less have been developed. Therefore, for the base substrate 1, substrates on which the flatness of the surface or back, the parallelism of both sides, the circumferential swell of the base substrate, and the roughness of both sides are adequately controlled are preferable.

(Underlayer)

The underlayer 2 of the magnetic recording medium 10 of the present invention can be formed by the sputtering or deposition method. It is principally composed of an alloy of two elements, and the one with a difference of standard free energy ΔG° for producing an oxide or a nitride of both elements at room temperature is 70 kJ/mol [O² or N²] or more is used. And the crystal grains of the underlayer 2 related with the present invention are composed principally of an element with a higher value ΔG° of these two elements, and an element with a lower value ΔG° form oxides or nitrides and are segregated in the crystal grain boundary of the underlayer 2. Due to such a structure, in the underlayer 2 of the present invention, fine crystal grains are separated and isolated by the crystal grain boundary and moreover crystal structure with a uniform crystal grain diameter is provided. Due to the crystal structure of this underlayer, the crystal grains become infinitely small in the intermediate layer 3 and the magnetic layer 4 formed on the underlayer 2, and crystal grains having highly isolated crystal structure are formed. Therefore, the magnetic interaction of crystal grains is reduced in the magnetic layer 4 and it is possible to realize a perpendicular magnetic recording medium having a low noise and outstanding recording and reproducing characteristics.

And it is possible to change the underlayer 2 into a multilayered structure composed of a number of layers laminated one on the other as required.

And when the difference of said ΔG° of the two elements composing principally the underlayer 2 is below 70 kJ/mol, the addition of an infinitely small amount of oxygen or nitrogen in the film during film forming makes it difficult to transform the underlayer into a separated two-phase structure and the effect of reducing the magnetic interaction among crystal grains of the magnetic layer cannot be obtained.

As for the components of said underlayer 2, it is preferable to adopt more specifically any one of B, Al, Si, Ti, Zr, Hf, Ta, Mn, Mg, Ca, Be and Ce for an element of a lower value of ΔG° of the two elements composing principally the underlayer 2, and any one of Cu, Zn, Nb, Mo, Tc, Ru, Rh, Pd, Ag, Cd, In, Sn, Re, Os, Ir, Pt and Au for an element of a higher value of ΔG° mentioned above. As specific examples of alloys used in the underlayer 2 of the present invention composed principally of alloy of two kinds of elements mentioned above, PdSi alloy, NiZr alloy, NiTa alloy, NiNb alloy, NbAl alloy, NbSi alloy, RuSi alloy, RuAl alloy, RuZr alloy and the like can be mentioned. In addition, Cr, Co, B, Ta and other elements may be added as required to the alloy composing the underlayer 2.

It is preferable that, in the alloy composing said underlayer 2, the contents of the element with said lower value ΔG° be 10 at % or above and 90 at % or below. When said contents are below 10 at %, it is difficult to form a crystal grain boundary with a uniform width, and in excess of 90 at %, the crystal grain boundary becomes too wide and the crystal grain diameter becomes too small and therefore the recording density of the medium declines.

And it is more preferable that the contents of the element with said lower value ΔG° be 20 at % or above and 60 at % or below, and by limiting the same within such a range, it will be possible to control the width of the crystal grain boundary to the optimum width and to regulate the magnitude of the magnetic interaction of the medium matching with the target recording density.

And it is more preferable that the contents of the element with said higher value ΔG° be 10 at % or above and 90 at % or below. When said contents are below 10 at %, the crystal grain boundary becomes too wide and the crystal grain diameter becomes too small resulting in a decrease of the recording density of the medium, and in excess of 90 at %, it will be difficult to form a crystal grain boundary with a uniform width.

And it is more preferable that the contents of the element with said higher value ΔG° be 40 at % or above and 80 at % or below, and by limiting the same within such a range, it will be possible to control the width of the crystal grain boundary to the optimum width and to regulate the magnitude of the magnetic interaction of the medium matching with the target recording density.

And it is preferable that the film thickness of said underlayer 2 be 0.5 nm or above and 25 nm or below. When the film thickness is 0.5 nm or below, the growth of the crystal grains of the underlayer 2 will be insufficient. In excess of 25 nm, on the other hand, the crystal grain diameter of the underlayer 2 will become large and course resulting in an increase of the medium noise.

(Intermediate Layer)

It is preferable that the intermediate layer 3 formed between the underlayer 2 and the magnetic layer 4 be formed to accelerate the epitaxial growth of the magnetic layer, and be composed of a metal film having a face centered cubic structure (fcc) or a hexagonal close-packed structure (hcp). The materials for composing this intermediate layer 3 is not specially limited. However, CoCr alloy, CoCrRu alloy, Pd, Cu, Pt, Ru and the like may be mentioned.

It is preferable that the film thickness of the intermediate layer 3 be 0.5 nm or above and 10 nm or below. When the film thickness is below 0.5 nm, the growth of the crystal grains in the film will be insufficient. In excess of 10 nm, on the other hand, the crystal grain diameter of the magnetic layer will become large and course.

(Magnetic Layer)

The magnetic layer 4 is, as shown in FIG. 1, a multilayered Co/Pd film comprising multiple layers of Co layer 4a composed principally of Co and Pd layer 4b composed principally of Pd laminated alternatively one on the other a number of times.

As materials for composing the Co layer 4a, alloy composed only of Co or alloy having a composition of CoX may be used. It is preferable that said X be any of B, Al, Si, Ti, Zr, Hf, Ta, Mn, Mg, Ca, Be and Ce. By using such CoX alloys, it will be possible to segregate the X element in the crystal grain boundary and to cover ferromagnetic crystal grains causing the magnetic interaction to diminish in the magnetic layer. The film thickness of this Co layer 4a is not specifically limited, but it is for example in a range of 0.2 nm-0.35 nm, because it is in this film thickness range that the perpendicular magnetic anisotropy of the medium shows the maximum value.

As the materials composing the Pd layer 4b, simple substance Pd as well as alloys of elements such as Pd and PdB, PdSi, PdAl and the like may be used, and in certain cases Pd may be replaced by Pt as the principal component of such materials. The film thickness of this Pd layer 4b is not specifically limited, but it is for example in a range of 0.8 nm-1.2 nm.

And the number of laminated layers of Co layer 4a and Pd layer 4b in the magnetic layer 4 composed of said multilayered Co/Pd film may be optionally chosen to constitute the optimum number of layers depending on the characteristics of the magnetic head combined with the perpendicular recording medium 10.

On certain perpendicular recording media having a magnetic layer composed of the multilayered Co/Pd film of said composition, the medium noise resulting from the magnetic interaction of the magnetic layer has been an issue. On the perpendicular recording medium related with the present invention, however, due to the action of the underlayer 2 described above, it is possible to enhance the magnetic isolation of crystal grains composing the magnetic layer 4 and to reduce the magnetic interaction in the magnetic layer 4. And hence it is possible to obtain a perpendicular recording medium having an outstanding recording and reproducing characteristic and capable of addressing to a high recording density.

The present mode of carrying out describes the case of composing the magnetic layer 4 of a multilayered Co/Pd film. In the perpendicular recording medium related with the present invention, however, the magnetic layer 4 may be formed by using an alloy principally composed of Co and Cr. In case a magnetic layer composed of the CoCr alloy is adopted, the action of the underlayer 2 enables to form a magnetic layer the crystal grains of which are fine and moreover highly isolated. This leads to a reduction of the magnetic interaction among magnetic crystal grains and the formation of a perpendicular recording medium having an outstanding noise characteristic.

The following is the description of the production process of the magnetic recording medium 10 of said construction by the sputtering method.

(Sputtering Method)

As the sputtering method constituting an example of the method of producing the magnetic recording medium 10 related to the present invention, the transferring-type sputtering method wherein the thin film is formed while the base substrate 1 moves before the target, and the static-type sputtering method wherein the thin film is formed while the base substrate 1 remains fixed before the target can be shown as examples.

The former transferring-type sputtering method is productive and suitable for mass production, and is therefore advantageous for the production of magnetic recording media at a low cost, while the latter static-type sputtering method enables to produce magnetic recording media having an outstanding recording and reproducing characteristic because of a stable angle of incidence of the sputtering particles in relation with the substrate 1. The sputtering method used for producing the magnetic recording media 10 related with the present invention is not limited to the transferring-type and the static-type.

The magnetic recording medium 10 related with the present invention can be produced by using said sputtering method for forming successively on the base substrate 1 thin film of the underlayer 2, the intermediate layer 3, the magnetic layer 4 (repeated lamination of the Co layer 4a and the Pd layer 4b) and the protective layer 5 one on the other.

And the magnetic recording medium 10 according to the production method of the present mode of carrying out is produced as follows: During and after the deposition of the underlayer 2, the base substrate 1 is disposed in the atmosphere containing oxygen and/or nitrogen, and oxides or nitrides of the elements composing the underlayer 2 are formed in the underlayer 2. The underlayer 2 is, as described above, principally composed of an alloy of two kinds of elements whose standard free energy ΔG° for producing an oxide or a nitride of both elements is different, and the difference of their ΔG° is set at 70 kJ/mol or above. Therefore, when the underlayer 2 is deposited by using a film forming gas containing oxygen or nitrogen, an oxide or a nitride of elements having a relatively small value ΔG° is formed in the underlayer 2, and moreover the oxide or nitride is disposed in the boundary of crystal grains composed principally of an element having a relatively large value ΔG° described above. For example, in the case of depositing on the underlayer composed of PdSi by applying the sputtering method based on the use of Ar/O₂ gas, a phase principally composed of an oxide of Si segregates around fine crystal grains principally composed of Pd. In the underlayer 2 thus deposited, crystal grains principally composed of an element having a higher value ΔG° are highly isolated by the oxide or nitride of elements with a lower value ΔG°, and at the same time the crystal grains become fine and their grain diameter distribution becomes uniform. Accordingly, the crystal grains of the intermediate layer 3 and the magnetic layer 4 formed on this underlayer 2 become fine and uniformly distributed. Therefore, the magnetic interaction in the magnetic layer 4 is mitigated and the medium noise is reduced.

When the underlayer 2 is deposited by using said film forming gas containing oxygen or nitrogen, depending on the material composing the underlayer 2, the addition of excessive amount of oxygen or nitrogen sometimes causes oxygen or nitrogen to disperse in the intermediate layer or magnetic layer which are above the underlayer and results in the deterioration of crystallinity. Therefore, it is preferable that the amount of oxygen or nitrogen added be kept within a range of 10⁻⁶ Torr or above and 6×10⁻² Torr or below in terms of the partial pressure of a mixed gas with Ar or rare gas.

And the production method related to the present invention allows, after the deposition on the underlayer 2, to expose the surface of the underlayer 2 to an atmosphere containing oxygen and/or nitrogen. By such an exposure, it is possible to have the surface of the underlayer 2 adsorb a given amount of oxygen and/or nitrogen, to make the crystal grains of the intermediate layer 3 and the magnetic layer 4 formed on the underlayer 2 infinitesimally small and to diminish magnetic interactions in the magnetic layer 4. By this exposure process, it is possible to control the amount of adsorption into the surface of the underlayer 2 by the partial pressure of oxygen and nitrogen and the length of exposure. However, the partial pressure of oxygen and nitrogen and the length of exposure in the actual production process may be set as required at the optimum values depending on the affinity of the materials composing the underlayer 2 with oxygen. And a gas resulting from the dilution of oxygen or nitrogen by a rare gas may be used.

And the underlayer 2 related with the present invention may comprise a plurality of layers laminated one on the other. However, in the production method related with the present invention, the layer formed nearest to the magnetic layer 4 among the layers composing the underlayer 2 may be deposited by applying the deposition method described above. In other words, if the underlayer 2 comprises a PdSi layer laminated on a NiZr film, the disposition of an oxide or nitride of an element with a small value ΔG° (Si) around crystal grains principally composed of an element with a higher value ΔG° (Pd) at least in the PdSi film can bring about the effect reducing the magnetic interaction of the magnetic layer 4. It is needless to say in this. regard that said deposition method may be applied to the NiZr film disposed below said PdSi film (on the side of the base substrate).

Or, it is possible to use a mixed gas obtained by adding oxygen and/or nitrogen to Ar or other rare gas for depositing the magnetic layer 4 and to reduce thereby the magnetic interaction of the magnetic layer 4. This method which leads to the adsorption of oxygen or nitrogen within the magnetic layer 4 sometimes causes the crystallinity and the coercive force of the magnetic layer 4 to decline. Therefore, when oxygen or nitrogen is to be added to the film forming gas of the magnetic layer 4, it is preferable that its contents be contained within a range of 10⁻⁶ Torr or above and 6×10⁻² Torr or below in terms of the partial pressure of a mixed gas with Ar or rare gas.

(Embodiments)

The present invention will be described in more details by showing embodiments. However, the present invention is not limited to these embodiments.

(Embodiment 1)

In the present embodiment, the perpendicular recording media were produced under various conditions, and their magnetic characteristics were evaluated.

On a crystallized glass base substrate, a seed layer (underlayer) composed of NiZr₄₀ was deposited, and after an exposure of the surface of said NiZr seed layer to the atmosphere, a Pd base (intermediate layer) with a film thickness of 5 nm, a [CoB₁₅ (film thickness: 0.2 nm)/Pd (film thickness: 1 nm)]₂₀ magnetic film (magnetic layer), a C protective film (protective layer) were successively deposited one on the other by the sputtering method to produce a perpendicular recording medium. It should be noted that said magnetic film is a multilayered Co/Pd film wherein the CoB layer and the Pd layer are alternatively laminated 20 times.

In the present embodiment, a total of six different samples were produced by changing the thickness of the seed layer in a range of 1 nm-10 nm including an embodiment without any seed layer. The structure and the deposition conditions of the magnetic recording media produced in the present embodiment are as follows:

The basic structure: Crystallized glass base substrate/NiZr₄₀ seed layer (film thickness: 0-10 nm)/Pd base (film thickness: 5 nm)/[CoB₁₅ (film thickness: 0.2 nm)/Pd (film thickness: 1 nm)]₂₀ magnetic film/C protective film (film thickness: 6 nm)

Temperature of the base substrate: room temperature

Gas pressure at the time of depositing the NiZr seed layer: 5 mTorr

Gas pressure at the time of depositing the Pd base and the magnetic film: 60 mTorr

And as comparative samples, perpendicular recording media of the identical structure as the one described above were produced with exceptions that an ITO seed layer was used for the underlayer 2 and that the film thickness was varied within a range of 1-5 nm.

The results of evaluation of the magnetic characteristics of the magnetic recording media produced as described above are shown in FIGS. 2 and 3. FIG. 2 shows the result of measurement of coercive force Hc, and FIG. 3 shows the result of measurement of anisotropic magnetic field Hk.

To begin with, as shown in FIG. 2 graph, it was confirmed that the coercive force Hc of the perpendicular recording media having the structure of the present invention by adopting the NiZr₄₀ seed layer improved by approximately 600-1,500 Oe as compared with the media having the conventional ITO seed layer. And it was confirmed that Hc improved by approximately 2k Oe in comparison with media without any seed layer.

While the NiZr₄₀ seed layer was exposed to the atmosphere after its deposition had been completed in the present Embodiment, the exposure of the NiZr₄₀ seed layer to a mixed gas containing oxygen or nitrogen resulted in an equivalent coercive force.

FIG. 3 is a graph showing the dependence of the anisotropic magnetic field Hk of the medium on the thickness of the seed layer. As this figure shows, the Hk value shows a constant level at approximately 30 kOe irrespective of the presence, thickness and material of the seed layer. From this fact, it is possible to assume that an increase in the value of Hc due to the use of the NiZr seed layer shown in FIG. 2 is not attributable to an increased strength of the anisotropic magnetic field of the magnetic layer, but it is attributable to a decrease in the magnetic interaction among crystal grains in the magnetic layer.

And the production by following the conditions described above of perpendicular recording media having a seed layer of Ni₅₀Ta₄₀ or a seed layer of Ni₅₀Nb₄₀ instead of said seed layer of NiZr and the evaluation of their magnetic characteristics revealed that the media having any of the seed layers showed an improvement of coercive force of 600 Oe or above in comparison with the media having ITO seed layers, and their Hk value was constant irrespective of the presence and thickness of the seed layer.

(Embodiment 2)

Then, as the Embodiment 2, on a crystallized glass base substrate, a seed layer (underlayer) composed of NiZr having a film thickness of 2.5 nm, a seed layer composed of PdSi₁₈ (underlayer) with a film thickness of 5 nm, a magnetic film (magnetic layer) composed of [CoB₁₅ (film thickness: 0.2 nm)/Pd (film thickness: 1 nm)]₂₀, a carbon protective film (protective layer) were successively deposited one on the other to produce a perpendicular recording medium. In other words, in this Embodiment, a perpendicular recording medium having a double-layered underlayer composed of a NiZr seed layer and a PdSi seed layer was produced.

In this Embodiment, a plurality of samples were produced using pure Ar gas or a mixed gas Ar/O₂ as film forming gas and varying the flow rate of O₂ gas in the film forming gas in the deposition process of the PdSi seed layer and the magnetic layer. The flow rate of the Ar gas was set constant at 110 sccm irrespective of whether O₂ was added or not. The structure and the deposition conditions of the magnetic recording media produced in this Embodiment are as follows:

The basic structure: Crystallized glass base substrate/NiZr₄₀ seed layer (film thickness: 2.5 nm)/PdSi₁₈ seed layer (film thickness: 5 nm)/[CoB₁₅ (film thickness: 0.2 nm)/Pd (film thickness: 1 nm)]₂₀ magnetic film/C protective film (film thickness: 6 nm)

Temperature of the base substrate: room temperature

Gas pressure at the time of depositing the NiZr seed layer: 5 mTorr

Gas pressure at the time of depositing the PdSi seed layer and the magnetic film: 60 mTorr

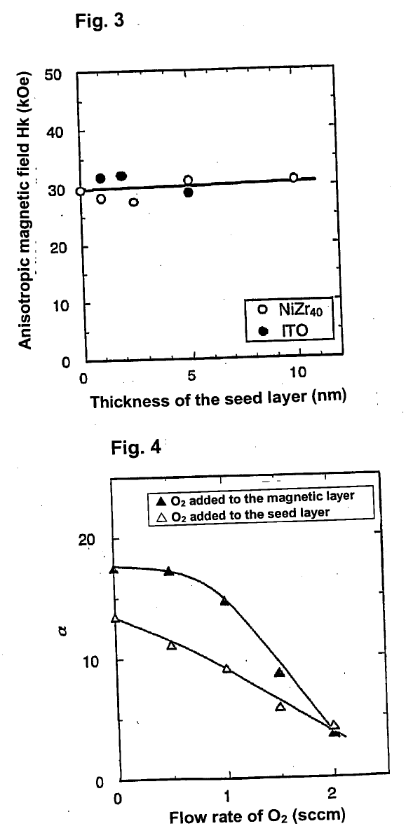

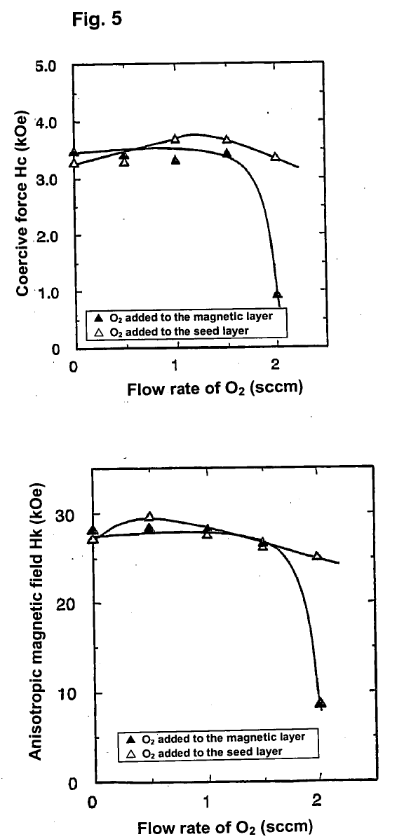

The results of evaluation of the magnetic characteristics of the magnetic recording media produced as described above are shown from FIGS. 4 to 6. FIG. 4 shows the dependence of a squareness ratio α of the media obtained as described above on the flow rate of O₂ gas, FIG. 5 shows the result of measurement of the coercive force Hc of the same, and FIG. 6 shows the result of measurement of the anisotropic magnetic field Hk of the same.

The magnitude of the coercivity squareness ratio α of the multilayered (CoB/Pd) film medium having a PdSi₁₈ seed layer shown in FIG. 4 corresponds to the strength of the exchange interaction among magnetic crystal grains. As shown in FIG. 4, α value diminishes monotonously proportionately to the amount of O₂ added irrespective of whether O₂ is added to the magnetic layer or the same is added to the PdSi₁₈ seed layer, and in samples in which the flow rate of O₂ is set at 2 sccm (approximately 0.3 m Torr), the magnitude of the α value decreased to approximately 3. From this fact, it was confirmed that the addition of O₂ to the magnetic layer or the PdSi₁₈ seed layer causes the magnetic interactions among crystal grains to diminish substantially.

And now the dependence of the coercive force Hc of the medium shown in FIG. 5 on the addition of oxygen gas will be described. When O₂ is added to the film forming gas for a deposition on the PdSi₁₈ seed layer, even if O₂ is added to the film forming gas up to 2.0 sccm (approximately 0.3 m Torr), Hc value remains constant at 3.5 kOe. However, when O₂ is added up to 2.0 sccm (approximately 0.3 m Torr) for a deposition on the magnetic layer, Hc value falls down sharply to 1.0 kOe.

Then, anisotropic magnetic field Hk shown in FIG. 6, like said coercive force Hc, hardly changes as a result of the addition of O₂ for the formation of the PdSi₁₈ seed layer. On the other hand, at the time of addition of O₂ for the formation of the magnetic layer, when the flow rate of O₂ is set at 2.0 sccm, Hk value falls down sharply.

These facts suggest that the addition of an excessive amount of O₂ to the magnetic layer causes the anisotropic magnetic field Hk of the magnetic layer (in other words, potential power for the coercive force of magnetic materials) to decrease substantially, and as a result the coercive force of the medium decreases sharply. From this fact, it was confirmed that in order to make a multilayered medium having a small α value and a high Hc value compatible, the process of adding O₂ to the PdSi₁₈ seed layer is very effective, and that, when O₂ is added to the magnetic layer, a control of the amount of O₂ added to an adequate range produces a meaningful result.

And then, the media were subjected to sectional TEM observations in order to clarify the effect of adding O₂ to the PdSi₁₈ seed layer of the Embodiment. As a result, it was found that the PdSi₁₈ underlayer which should essentially be amorphous has been crystallized. And it was also found that the crystal grains of this PdSi₁₈ seed layer have developed a Si-poor PdSi phase, and that the crystal grain boundary has developed an amorphous phase composed principally of SiO₂.

From this fact, it was confirmed that the addition of O₂ to the PdSi₁₈ seed layer caused Si having a small atomic radius and a high affinity with oxygen to segregate easily in the crystal grain boundary, and as a result the crystal grain boundary around the crystal grains principally composed of Pd which is an element having a higher value ΔG° will be principally composed of an oxide of Si which is an element having a lower value ΔG° composing the underlayer related to the present invention.

And it was confirmed that, in the magnetic film composed of a multilayered CoB/Pd film, B of the (CoB/Pd) magnetic film segregates along the crystal grain boundary of this PdSi₁₈ seed layer to form the crystal grain boundary of the magnetic layer. The fact that the magnetic interactions among magnetic crystal grains are reduced substantially in the magnetic recording medium of this Embodiment is likely to be attributable to B that has segregated along the grain boundary of this seed layer.

And as a result of TEM observations carried out on the magnetic recording media of the conventional structure having an ITO seed layer produced in said Embodiment 1, B segregated very little despite the identity of the media of this Embodiment in terms of the structure of magnetic layer. This fact reveals that the accelerated segregation of B in the magnetic layer of the medium of this Embodiment is attributable to the PdSi seed layer having the structure of the present invention.

Incidentally, the DC magnetron sputtering method was used to form various layers composing the medium in said Embodiment. However, it is needless to say that the RF sputtering method, the laser deposition method, the ion beam film forming method and other film forming methods can be used.

As for the sputtering gas for forming the magnetic layer, krypton Kr and xenon Xe having a greater valence than Ar are preferable. The use of these gases impedes the possibility of mixing between layers of the multilayered Co/Pd film and leads to the development of a high perpendicular magnetic anisotropy.

(Magnetic Recording Apparatus)

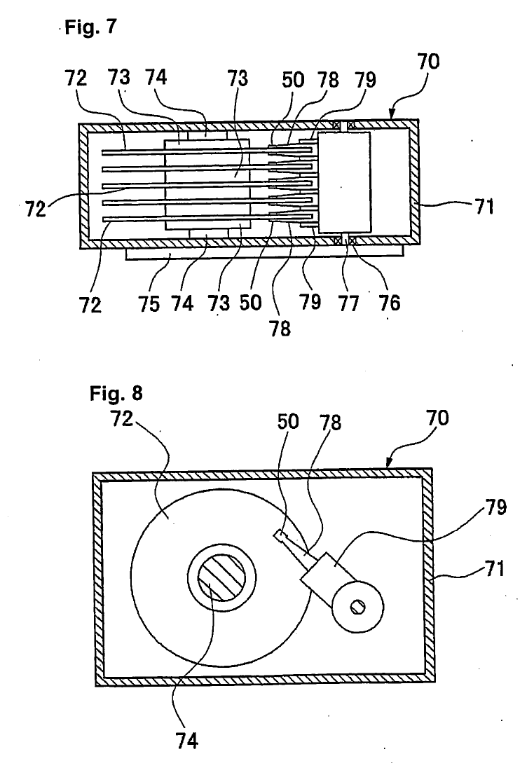

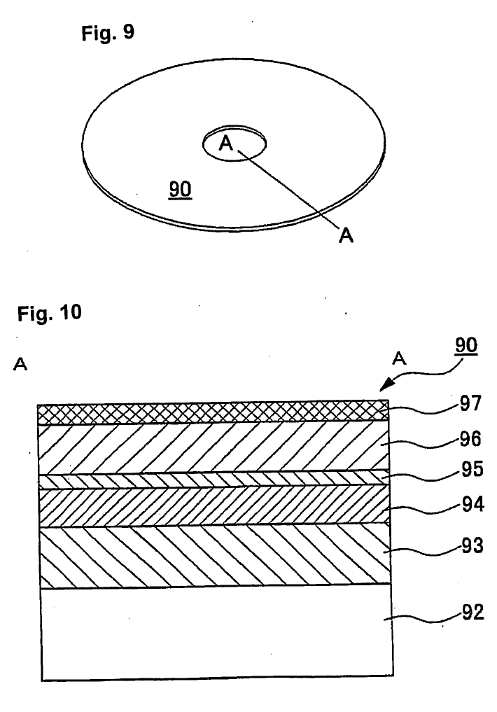

And now the magnetic recording apparatus related to the present invention will be described below with reference to drawings. FIG. 7 is a cross sectional view showing an example of hard disk drive which is a magnetic recording apparatus related to the present invention, and FIG. 8 is a plane view of the magnetic recording apparatus shown in FIG. 7. In FIGS. 7 and 8, 50 represents a magnetic head, 70 a hard disk drive, 71 a housing, 72 a magnetic recording medium, 73 a spacer, 79 a swing arm, and 78 a suspension. The hard disk drive 70 related to the present mode of carrying out mounts said magnetic recording medium of the present invention.

The hard disk drive 70 is externally constituted by the rectangular housing 71 having an inner space for housing the discoidal magnetic recording media 72, the magnetic head 50 and other elements. This housing 71 contains inside a plurality of magnetic recording media 72 skewered alternatively with spacers 73 on a spindle 74. And the housing 71 contains a bearing (not shown) for the spindle 74, and on the outside of the housing 71 there is a motor 75 for rotating the spindle 74. By this structure, all the perpendicular recording media 72 are kept rotatively around the spindle 74 all being bundled together while leaving intervals with spacers 73 for allowing the approach of magnetic heads 50.

In the housing 71 and beside the magnetic recording medium 72, there is a rotary shaft 77 called “rotary actuator” being supported by the bearing 76 in parallel with the spindle 74. This rotary shaft 77 is provided with a plurality of swing arms 79 protruding in the space between each magnetic recording medium 72. At the tip of each swing arm 79, a magnetic head 50 is fixed through a slender triangular suspension 78 fixed diagonally opposite to the surface of each magnetic recording medium 72 located above or below the same. This magnetic head 50 is provided with a recording element not shown for writing information on the magnetic recording medium 72 and a reproduction element not shown for. reading information from the magnetic recording medium 72.

It is possible according to said structure to rotate the magnetic recording medium 72, to move the magnetic head 50 in the radius direction of the magnetic recording medium 72 by the movement of the swing arm 79, and therefore the magnetic head 50 can move to any position on the magnetic recording medium 72.

The hard disk drive 70 of the structure described above can write desired magnetic information on a magnetic recording medium 72 by rotating the magnetic recording medium 72, by moving the swing arm 79 and by causing the magnetic field generated by this magnetic head 50 act on the ferromagnetic metal layer composing the magnetic recording medium 72. It also can read magnetic information by moving the swing arm 79 and the magnetic head 50 to an optional position on the magnetic recording medium 72 and by detecting the leakage magnetic field from the magnetic layer constituting the magnetic recording medium 72 by means of the reproduction element of the magnetic head.

If, in connection with reading and writing magnetic information as shown above, the magnetic recording medium 72 has an outstanding recording and reproducing characteristics as described above, it is possible normally to record and reproduce at a high recording density and to provide a high-speed hard disk drive 70 with a large capacity.

Incidentally, the hard disk drive 70 described above with reference to FIGS. 7 and 8 show only an example of magnetic recording apparatuses, and the number of magnetic recording media mounted on the magnetic recording apparatus may be any optional number of one or more, and the number of magnetic heads mounted may be any optional number of one or more. And the shape and the driving system of the swing arm 79 are not limited to those shown on the figure, and the linear driving system and any other systems may obviously be adopted.

### INDUSTRIAL APPLICABILITY

As described above in details, the perpendicular recording medium of the present invention is characterized in that said underlayer comprises an alloy principally composed of two kinds of elements, the difference of standard free energy ΔG° for forming an oxide or a nitride at room temperature of said both elements is set at 70 kJ/Mol [O₂ or N₂] or above, the crystal grains constituting said underlayer is principally composed of an element having a higher value ΔG° among said two elements, and the crystal grain boundary of said underlayer is principally composed of an oxide or a nitride of elements having a lower value ΔG° . For all these facts, it is possible to obtain a high coercive force, to reduce the magnetic interactions among crystal grains in the magnetic layer and therefore to record and reproduce information at a high recording density.

On the other hand, the production method related with the present invention comprises a step of forming the underlayer on a nonmagnetic base substrate and a step of forming the magnetic layer for recording magnetic information on said underlayer. The step of forming said underlayer comprises a step of forming an oxide or a nitride of at least one kind or more of elements among those constituting the underlayer in the underlayer. By such a process, it is possible to produce easily a perpendicular recording medium wherein the magnetic interactions among crystal grains in said magnetic layer are small and yet recording and reproducing characteristics are outstanding.

1. A perpendicular recording medium comprising a nonmagnetic base substrate, an underlayer formed directly or indirectly on said nonmagnetic base substrate, and a magnetic layer formed on said underlayer for recording magnetic information, wherein
said underlayer comprises an alloy principally composed of two kinds of elements, the difference of standard free energy ΔG° for producing an oxide or a nitride of said both elements at room temperature is set at 70 kJ/mol [O₂ or N₂] or above,
the crystal grains constituting said underlayer are principally composed of elements having a higher value ΔG° of said two elements, and
the crystal grain boundary of said underlayer is principally composed of an oxide or a nitride of said element having a lower value ΔG°.

2. The perpendicular recording medium according to claim 1, wherein the element having a lower value ΔG° contained in said underlayer is any one of B, Al, Si, Ti, Zr, Hf, Ta, Mn, Mg, Ca, Be and Ce.

3. The perpendicular recording medium according to claim 2, wherein the contents of elements having a lower value ΔG° contained in said underlayer is 10 at % or above and 90 at % or below.

4. The perpendicular recording medium according to claim 2, wherein the contents of elements having a lower value ΔG° contained in said underlayer is 20 at % or above and 60 at % or below.

5. The perpendicular recording medium according to claim 1, wherein the element having a higher value ΔG° contained in said underlayer is any one of Cu, Zn, Nb, Mo, Tc, Ru, Rh, Pd, Ag, Cd, In, Sn, Re, Os, Ir, Pt and Au.

6. The perpendicular recording medium according to claim 5, wherein the contents of elements having a higher value ΔG° contained in said underlayer is 10 at % or above and 90 at % or below.

7. The perpendicular recording medium according to claim 5, wherein the contents of elements having a higher value ΔG° contained in said underlayer is 40 at % or above and 80 at % or below.

8. The perpendicular recording medium according to claim 1, wherein the film thickness of said underlayer is 0.5 nm or above and 25 nm or below.

9. The perpendicular recording medium according to claim 1 comprising an intermediate layer between said underlayer and the magnetic layer wherein,
said intermediate layer has a face centered cubic structure (fcc) or a hexagonal close-packed structure (hcp).

10. The perpendicular recording medium according to claim 9, wherein the film thickness of said intermediate layer is 0.5 nm or above and 10 nm or below.

11. The perpendicular recording medium according to claim 1, wherein said magnetic layer comprises an alloy principally composed of Co and Cr.

12. The perpendicular recording medium according to claim 1, wherein said magnetic layer is a multilayered film comprising layers principally composed of Co and layers principally composed of Pd alternatively laminated one on the other a number of times.

13. The perpendicular recording medium according to claim 12, wherein said layer principally composed of Co is composed of a CoX alloy, said X being any one of B, Al, Si, Ti, Zr, Hf, Ta, Mn, Mg, Ca, Be and Ce.

14. A method of producing the perpendicular recording media comprising
a step of forming the underlayer on the nonmagnetic base substrate, and
a step of forming the magnetic layer for recording magnetic information on said underlayer, wherein
an oxide or a nitride of at least one kind of element or more elements among the elements composing the underlayer is or are formed in the underlayer in said step of forming the underlayer.

15. The method of producing perpendicular recording media according to claim 14 wherein,
said underlayer comprises an alloy principally composed of two kinds of elements, and
said both elements comprise two elements of which the difference of standard free energy ΔG° for forming an oxide or a nitride in room temperature is 70 kJ/mol [O₂ or N₂] or above.

16. The method of producing perpendicular recording media according to claim 14, wherein a film forming gas containing oxygen or nitrogen is used in the step of depositing said underlayer, the partial pressure of oxygen or nitrogen in said film forming gas being 10⁻⁶ Torr or above and 6×10⁻² Torr or below.

17. The method of producing perpendicular recording media according to claim 14, wherein a film forming gas containing oxygen or nitrogen is used in the step of depositing said magnetic layer, the partial pressure of oxygen or nitrogen in said film forming gas being 10⁻⁶ Torr or above and 6×10⁻² Torr or below.

18. The method of producing perpendicular recording media according to claim 14 comprising a step of exposing the surface of said underlayer to the atmosphere containing oxygen or nitrogen after the deposition of said underlayer.

19. The method of producing perpendicular recording media according to claim, wherein an alloy of which the element with and having a lower value ΔG° is any one of B, Al, Si, Ti, Zr, Hf, Ta, Mn, Mg, Ca, Be and Ce is used as an alloy composing said underlayer.

20. The method of producing perpendicular recording media according to claim 17 wherein the contents of the element having a lower value ΔG° and contained in said alloy is 10 at % or above and 90 at % or below.

21. The method of producing perpendicular recording media according to claim 17, wherein the contents of the element having a lower value ΔG° and contained in said alloy is 20 at % or above and 60 at % or below.

22. The method of producing perpendicular recording media according to claim 15, wherein an alloy of which the element with a higher value ΔG° is any one of Cu, Zn, Nb, Mo, Tc, Ru, Rh, Pd, Ag, Cd, In, Sn, Re, Os, Ir, Pt and Au is used as an alloy composing said underlayer.

23. The method of producing perpendicular recording media according to claim 19, wherein the contents of the element having a higher value ΔG° and contained in said alloy is 10 at % or above and 90 at % or below.

24. The method of producing perpendicular recording media according to claim 19, wherein the contents of the element having a higher value ΔG° and contained in said alloy is 40 at % or above and 80 at % or below.

25. A magnetic recording apparatus comprising a perpendicular recording medium according to claim 1, a driving part for driving said perpendicular recording medium, and a magnetic head for recording and reproducing magnetic information, wherein said magnetic head records and reproduces magnetic information on and from said perpendicular recording medium in motion.
